(19) United States
(12) Patent Application Publication
(10) Pub. No.: US 2021/0017733 A1
(43) Pub. Date: Jan. 21, 2021

(54) DIMENSION-SPECIFYING DEVICE AND DIMENSION-SPECIFYING METHOD

(71) Applicant: KOMATSU LTD., Tokyo (JP)

(72) Inventors: Yoshito KUMAKURA, Minato-ku, Tokyo (JP); Daiki ARIMATSU, Tokyo (JP)

(21) Appl. No.: 16/980,195

(22) PCT Filed: Mar. 12, 2019
(86) PCT No.: PCT/JP2019/010093

§ 371 Date: Sep. 11, 2020

(30) Foreign Application Priority Data
Apr. 26, 2018 (JP) 2018-085853

(51) Int. Cl. E02F 3/36; E02F 9/26

(52) U.S. Cl. CPC E02F 3/36; E02F 9/2025; E02F 9/264

(57) ABSTRACT

A dimension-specifying device specifies dimensions of an attachment of work equipment including an arm and the attachment. In the work equipment a first connection portion or a second connection portion provided at the attachment is connected to the arm. The dimension-specifying device includes a dimension storage unit and a dimension calculation unit. The dimension storage unit stores first dimensions of an attachment when a first connection portion is connected to an arm. The dimension calculation unit calculates second dimensions of the attachment when a second connection portion is connected to the arm on the basis of the first dimensions.

### CROSS-REFERENCE TO RELATED APPLICATIONS

This application is a U.S. National stage application of International Application No. PCT/JP2019/010093, filed on Mar. 12, 2019. This U.S. National stage application claims priority under 35 U.S.C. § 119(a) to Japanese Patent Application No. 2018-085853, filed in Japan on Apr. 26, 2018, the entire contents of which are hereby incorporated herein by reference.

### BACKGROUND

### Field of the Invention

The present invention relates to a dimension-specifying device and a dimension-specifying method for work equipment including an arm and a bucket.

### Background Information

Japanese Unexamined Patent Application, First Publication No. 2012-172431 discloses a display system that displays an image indicating a positional relationship between a position of teeth of a bucket and a design surface in order for an operator to accurately shape a target surface.

### SUMMARY

Depending on work contents at a construction site, a bucket of work equipment provided in a work machine such as a hydraulic excavator may be attached in an opposite direction. For example, in a case where a work machine is a backhoe excavator, the bucket is typically attached such that the teeth face a vehicle body. However, depending on work contents, the bucket may be attached such that the teeth face the front. That is, the backhoe excavator may be used as a loading excavator. Hereinafter, the bucket being attached in a normal manner will be referred to as a “normal connection”, and the bucket being attached in an opposite direction will be referred to as an “invert connection”.

The bucket has a teeth side connection portion and a heel side connection portion at a base-end portion, one of which is attached to a tip end of an arm and the other of which is attached to a cylinder. Therefore, when the bucket is brought into an invert connection state, the cylinder is attached to the connection portion to which the arm is attached at the time of normal connection, and the arm is attached to the connection portion to which the cylinder is attached at the time of normal connection.

In the display system described in Patent Literature 1, a dimension of the bucket is specified on the basis of dimension information of the bucket stored in a storage device. The dimension information of the bucket is information indicating a dimension of the bucket in a supposed method of attaching the bucket to the arm. On the other hand, a length from the tip end of the arm to the teeth of the bucket differs in the normal connection and in the invert connection. Therefore, the display system described in Japanese Unexamined Patent Application, First Publication No. 2012-172431 cannot accurately specify a dimension of the bucket in a case where the bucket is attached to the arm according to an attachment method different from the supposed attachment method.

An object of the present invention is to provide a dimension-specifying device and a dimension-specifying method capable of specifying a dimension of a bucket regardless of a bucket attachment method.

A first aspect of the present invention provides a dimension-specifying device specifying dimensions of an attachment of work equipment which includes an arm and the attachment and in which a first connection portion or a second connection portion provided at the attachment is connected to the arm, the dimension-specifying device including a dimension storage unit storing first dimensions that are dimensions of the attachment when the first connection portion is connected to the arm; and a dimension calculation unit calculating second dimensions that are dimensions of the attachment when the second connection portion is connected to the arm on the basis of the first dimensions.

According to the above aspect, the dimension specifying device can specify a dimension of a bucket regardless of a bucket attachment method.

### BRIEF DESCRIPTION OF DRAWINGS

FIG. 1 is a diagram showing an example of a posture of work equipment.

FIG. 2 is a schematic diagram showing a configuration of a work machine according to a first embodiment.

FIG. 3 is a block diagram showing configurations of a work equipment control device and an input/output device according to the first embodiment.

FIG. 4 is a diagram showing dimensions of a bucket in a normal connection state.

FIG. 5 is a diagram showing dimensions of a bucket in an invert connection state.

FIG. 6 is a diagram showing a method of calculating bucket dimensions in the invert connection state.

FIG. 7 is a flowchart showing a bucket setting method for the work machine according to the first embodiment.

FIG. 8 is a flowchart showing a bucket image display process and an intervention control process using set dimensions in the first embodiment.

FIG. 9 is a diagram showing an example of an image of the bucket.

FIG. 10 is a flowchart showing a bucket setting method for a work machine according to another embodiment.

### DETAILED DESCRIPTION OF EMBODIMENT(S)

Hereinafter, embodiments will be described in detail with reference to the drawings.

### <Coordinate System>

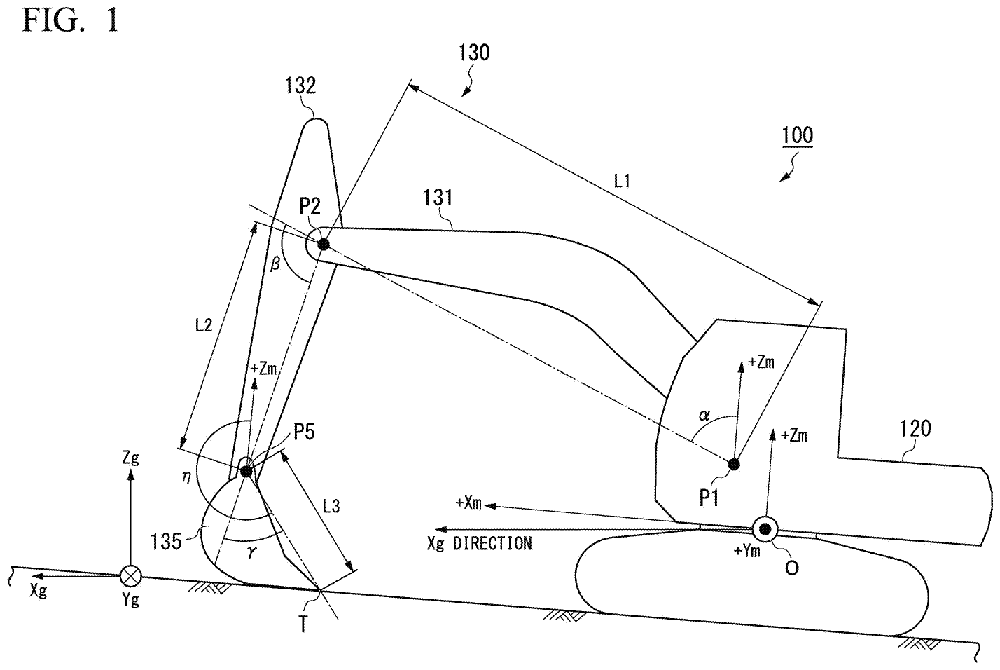

FIG. 1 is a diagram showing an example of a posture of work equipment.

In the following description, a three-dimensional site coordinate system (Xg, Yg, Zg) and a three-dimensional vehicle body coordinate system (Xm, Ym, Zm) are defined, and a positional relationship will be described on the basis of the coordinate systems.

The site coordinate system is a coordinate system formed of an Xg axis extending in the north and south, a Yg axis extending in the east and west, and a Zg axis extending in the vertical direction with a position of a GNSS reference station provided at a construction site as a reference point. An example of the GNSS is a global positioning system (GPS).

The vehicle body coordinate system is a coordinate system formed of an Xm axis extending forward and backward, a Ym axis extending leftward and rightward, and a Zm axis extending upward and downward with a representative point O defined on a swing body 120 of a work machine 100 which will be described later as a reference. The front will be referred to as a +Xm direction, the rear will be referred to as a −Xm direction, the left will be referred to as a +Ym direction, the right will be referred to as a −Ym direction, the upward direction will be referred to as a +Zm direction, and the downward direction will be referred to as a −Zm direction with the representative point O of the swing body 120 as a reference.

A work equipment control device 150 of the work machine 100 which will be described later may convert a position in a certain coordinate system into a position in another coordinate system through calculation. For example, the work equipment control device 150 may convert a position in the vehicle body coordinate system into a position in the site coordinate system and may also reversely convert positions in the coordinate systems into each other.

### First Embodiment

### <<Work Machine>>

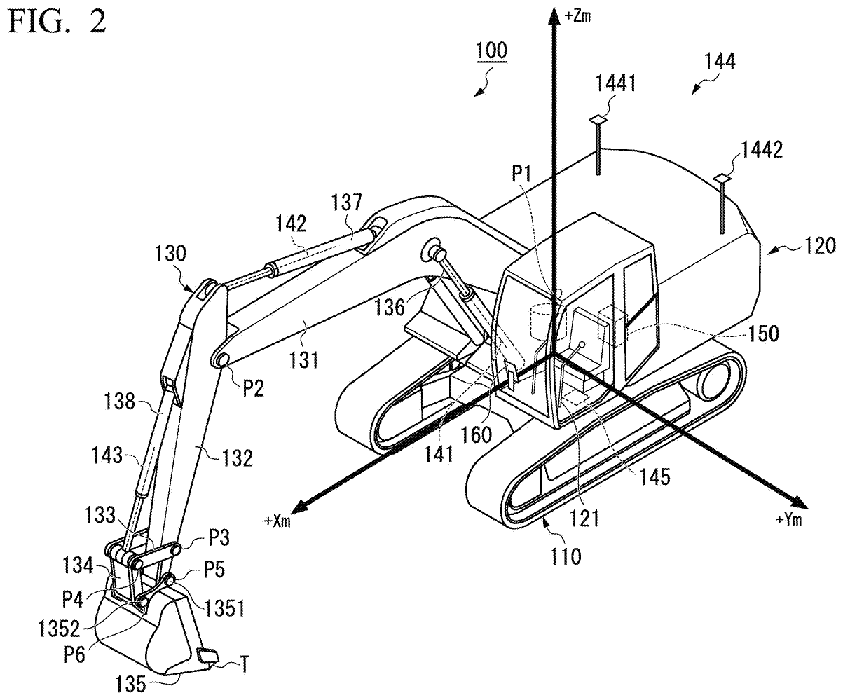

FIG. 2 is a schematic diagram showing a configuration of the work machine according to a first embodiment.

The work machine 100 includes a carriage 110, the swing body 120 supported at the carriage 110, and work equipment 130 that is operated by hydraulic pressure and is supported at the swing body 120. The swing body 120 is supported at the carriage 110 so as to be freely swingable around the swing center.

The work equipment 130 includes a boom 131, an arm 132, an idler link 133, a bucket link 134, a bucket 135, a boom cylinder 136, an arm cylinder 137, and a bucket cylinder 138.

A base-end portion of the boom 131 is attached to the swing body 120 via a boom pin P1.

The arm 132 connects the boom 131 to the bucket 135. A base-end portion of the arm 132 is attached to a tip-end portion of the boom 131 via an arm pin P2.

A first end of the idler link 133 is attached to a side surface of the arm 132 on the tip-end side thereof via an idler link pin P3. A second end of the idler link 133 is attached to a tip-end portion of the bucket cylinder 138 and a first end of the bucket link 134 via a bucket cylinder pin P4.

The bucket 135 includes teeth T for excavating earth and the like, and an accommodation portion for accommodating the excavated earth. Two connection portions for connection to the arm 132 and the bucket link 134 are provided at a base-end portion of the bucket 135. Hereinafter, the connection portion of the bucket 135 on the teeth T side thereof will be referred to as a front connection portion 1351, and the connection portion of the bucket 135 on the heel side thereof will be referred to as a rear connection portion 1352.

One connection portion (front connection portion 1351 in FIG. 2) of the bucket 135 is attached to the tip-end portion of the arm 132 via a bucket pin P5. The other connection portion (the rear connection portion 1352 in FIG. 2) of the bucket 135 is attached to the second end of the bucket link 134 via a bucket link pin P6. The bucket 135 may be a bucket for the purpose of leveling, such as a slope bucket, or may be a bucket that is not provided with an accommodation portion. The work equipment 130 according to another embodiment may include other attachments such as a breaker for hitting and crushing rocks instead of the bucket 135.

Hereinafter, a state in which the arm 132 and the bucket pin P5 are attached to the front connection portion 1351 of the bucket 135 and the bucket link 134 and the bucket link pin P6 are attached to the rear connection portion 1352 will be referred to as a normal connection state. On the other hand, a state in which the bucket link 134 and the bucket link pin P6 are attached to the front connection portion 1351 of the bucket 135 and the arm 132 and the bucket pin P5 are attached to the rear connection portion 1352 will be referred to as an invert connection state. The front connection portion 1351 is an example of a first connection portion or a second connection portion of another embodiment which will be described later. The rear connection portion 1352 is an example of a second connection portion or a first connection portion of another embodiment which will be described later.

The boom cylinder 136 is a hydraulic cylinder for operating the boom 131. A base-end portion of the boom cylinder 136 is attached to the swing body 120. A tip-end portion of the boom cylinder 136 is attached to the boom 131.

The arm cylinder 137 is a hydraulic cylinder for driving the arm 132. A base-end portion of the arm cylinder 137 is attached to the boom 131. A tip-end portion of the arm cylinder 137 is attached to the arm 132.

The bucket cylinder 138 is a hydraulic cylinder for driving the bucket 135. A base-end portion of the bucket cylinder 138 is attached to the arm 132. A tip-end portion of the bucket cylinder 138 is attached to the idler link 133 and the bucket link 134.

The swing body 120 includes an operation device 121, the work equipment control device 150, and an input/output device 160.

The operation device 121 is two levers provided inside a cab. The operation device 121 receives, from an operator, a raising operation and a lowering operation on the boom 131, a pushing operation and a pulling operation on the arm 132, an excavation operation and a dumping operation on the bucket 135, and a right swing operation and a left swing operation on the swing body 120. The carriage 110 receives a forward operation and a backward operation via levers (not shown).

The work equipment control device 150 specifies a position and a posture of the bucket 135 in the site coordinate system on the basis of measured values from a plurality of measurement devices which will be described later provided in the work machine 100. The work equipment control device 150 controls the work equipment 130 on the basis of an operation on the operation device 121. In this case, the work equipment control device 150 performs intervention control which will be described later on the operation on the operation device 121.

The input/output device 160 displays a screen indicating a relationship between the bucket 135 of the work machine 100 and a design surface of a construction site. The input/output device 160 also generates an input signal according to a user's operation and outputs the input signal to the work equipment control device 150. The input/output device 160 is provided in the cab of the work machine 100. As the input/output device 160, for example, a touch panel may be used. In other embodiments, the work machine 100 may include an input device and an output device separately, instead of the input/output device 160.

The work machine 100 includes a plurality of measurement devices. Each measurement device outputs a measured value to the work equipment control device 150. Specifically, the work machine 100 includes a boom stroke sensor 141, an arm stroke sensor 142, a bucket stroke sensor 143, a position and azimuth direction calculator 144, and a tilt detector 145.

The boom stroke sensor 141 measures a stroke amount of the boom cylinder 136.

The arm stroke sensor 142 measures a stroke amount of the arm cylinder 137.

The bucket stroke sensor 143 measures a stroke amount of the bucket cylinder 138.

Consequently, the work equipment control device 150 can detect a position and a posture angle of the work equipment 130 including bucket 135 in the vehicle body coordinate system on the basis of respective stroke lengths of the boom cylinder 136, the arm cylinder 137, and the bucket cylinder 138. In other embodiments, a position and a posture angle of the work equipment 130 in the vehicle body coordinate system may be detected by using a tiltmeter, an angle sensor such as an IMU, and other sensors attached to the work equipment 130 instead of the boom cylinder 136, the arm cylinder 137, and the bucket cylinder 138.

The position and azimuth direction calculator 144 calculates a position of the swing body 120 in the site coordinate system and an azimuth direction to which the swing body 120 is directed. The position and azimuth direction calculator 144 includes a first receiver 1441 and a second receiver 1442 that receive positioning signals from artificial satellites forming the GNSS. The first receiver 1441 and the second receiver 1442 are respectively installed at different positions on the swing body 120. The position and azimuth direction calculator 144 detects a position of the representative point O (the origin of the vehicle body coordinate system) of the swing body 120 in the site coordinate system on the basis of the positioning signal received by the first receiver 1441.

The position and azimuth direction calculator 144 calculates an azimuth direction of the swing body 120 in the site coordinate system by using the positioning signals received by the first receiver 1441 and the positioning signals received by the second receiver 1442.

The tilt detector 145 measures an acceleration and an angular velocity of the swing body 120 and detects a posture of the swing body 120 (for example, a roll indicating rotation about the Xm axis, a pitch indicating rotation about the Ym axis, and a yaw indicating rotation about the Zm axis) on the basis of the measurement result. The tilt detector 145 is installed, for example, on a lower surface of the cab. An example of the tilt detector 145 may be an inertial measurement unit (IMU).

### <<Posture of Work Equipment>>

Here, a position and a posture of the work equipment 130 will be described with reference to FIG. 1. The work equipment control device 150 calculates a position and a posture of the work equipment 130 and generates a control command for the work equipment 130 on the basis of the position and the posture. The work equipment control device 150 calculates a boom relative angle α that is a posture angle of the boom 131 with the boom pin P1 as a reference, an arm relative angle β that is a posture angle of the arm 132 with the arm pin P2 as a reference, a bucket relative angle γ that is a posture angle of the bucket 135 with the bucket pin P5 as a reference, and a position of the teeth T of the bucket 135 in the vehicle body coordinate system.

The boom relative angle α is represented by an angle formed between a half line extending from the boom pin P1 in the upward direction (+Zm direction) of the swing body 120 and a half line extending from the boom pin P1 to the arm pin P2. Depending on a posture (pitch angle) 0 of the swing body 120, the upward direction (+Zm direction) of the swing body 120 and the vertically upward direction (+Zg direction) do not necessarily match each other.

The arm relative angle β is represented by an angle formed between a half line extending from the boom pin P1 to the arm pin P2 and a half line extending from the arm pin P2 to the bucket pin P5.

The bucket relative angle γ is represented by an angle formed between a half line extending from the arm pin P2 to the bucket pin P5 and a half line extending from the bucket pin P5 to the teeth T of the bucket 135.

Here, a bucket absolute angle η, which is a posture angle of the bucket 135 about the Zm axis of the vehicle body coordinate system, is the same as the sum of the boom relative angle α, the arm relative angle β, and the bucket relative angle γ. The bucket absolute angle η is the same as an angle formed between a half line extending from the bucket pin P5 in the upward direction (+Zm direction) of the swing body 120 and the half line extending from the bucket pin P5 to the teeth T of the bucket 135.

A position of the teeth T of the bucket 135 is obtained by using a boom length L1 that is one dimension of the boom 131, an arm length L2 that is another dimension of the arm 132, a bucket length L3 that is another dimension of the bucket 135, the boom relative angle α, the arm relative angle β, the bucket relative angle γ, shape information of the bucket 135, a position of the representative point O of the swing body 120 in the site coordinate system, and a positional relationship between the representative point O and the boom pin P1. The boom length L1 is a distance from the boom pin P1 to the arm pin P2. The arm length L2 is a distance from the arm pin P2 to the bucket pin P5. The bucket length L3 is a distance from the bucket pin P5 to the teeth T of the bucket 135. The bucket pin P5 is attached to the front connection portion 1351 in the normal connection state and is attached to the rear connection portion 1352 in the invert connection state, and thus a distance from the front connection portion 1351 to the teeth T may not match a distance from the rear connection portion 1352 to the teeth T. In this case, the bucket length L3 has different values depending on whether the bucket 135 is in the normal connection state or the invert connection state. The positional relationship between the representative point O and the boom pin P1 is represented by, for example, a position of the boom pin P1 in the vehicle body coordinate system.

### <<Intervention Control>>

The work equipment control device 150 restricts a speed of the bucket 135 in a direction of approaching a construction target such that the bucket 135 does not enter a design surface set at a construction site. Hereinafter, the work equipment control device 150 restricting a speed of the bucket 135 will also be referred to as intervention control.

In the intervention control, the work equipment control device 150 generates a control command for the boom cylinder 136 such that the bucket 135 does not enter the design surface in a case where a distance between bucket 135 and the design surface is less than a predetermined distance. Consequently, the boom 131 is driven such that a speed of the bucket 135 becomes a speed corresponding to the distance between the bucket 135 and the design surface. That is, the work equipment control device 150 restricts the speed of the bucket 135 by raising the boom 131 according to the control command for the boom cylinder 136.

In other embodiments, a control command for the arm cylinder 137 or a control command for the bucket cylinder 138 may be generated in the intervention control. That is, in other embodiments, a speed of the bucket 135 may be restricted by raising the arm 132 in the intervention control, or a speed of the bucket 135 may be directly restricted.

### <<Work Equipment Control Device>>

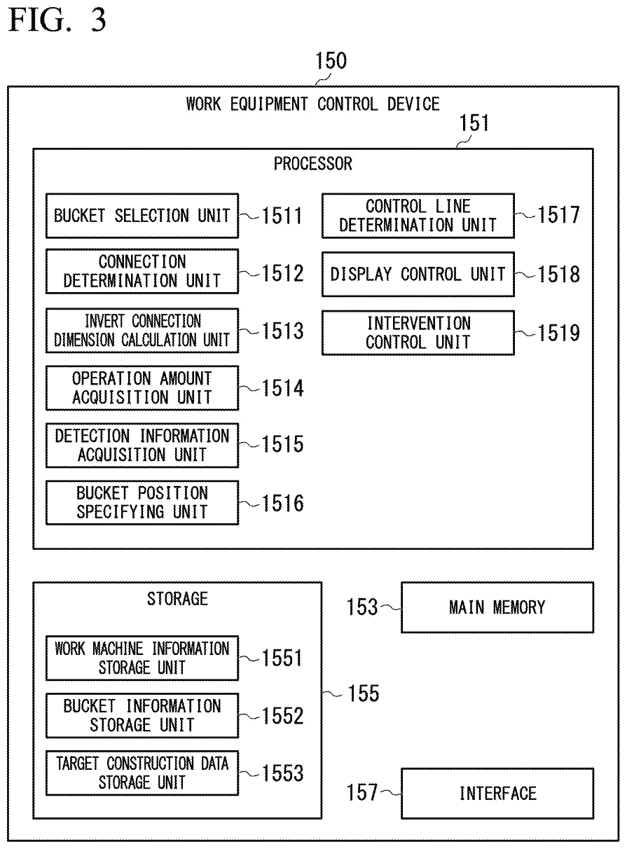

FIG. 3 is a block diagram showing the configurations of the work equipment control device and the input/output device according to the first embodiment. The work equipment control device 150 is an example of a dimension-specifying device.

The work equipment control device 150 includes a processor 151, a main memory 153, a storage 155, and an interface 157.

The storage 155 stores a program for controlling the work equipment 130. Examples of the storage 155 include a hard disk drive (HDD), a solid state drive (SSD), and a nonvolatile memory. The storage 155 may be an internal medium directly connected to a bus of the work equipment control device 150, and may be an external medium connected to the work equipment control device 150 via the interface 157 or a communication line.

The processor 151 reads the program from the storage 155, loads the program into the main memory 153, and executes a process according to the program. The processor 151 allocates a storage region in the main memory 153 according to the program. The interface 157 is connected to the operation device 121, the input/output device 160, the boom stroke sensor 141, the arm stroke sensor 142, the bucket stroke sensor 143, the position and azimuth direction calculator 144, the tilt detector 145, and other peripheral devices, and performs inputting and outputting of signals therewith.

The program may realize some functions of the work equipment control device 150. For example, the program may realize a function through a combination with another program already stored in the storage 155 or a combination with another program installed in another device. In other embodiments, the work equipment control device 150 may include a custom large scale integrated circuit (LSI) such as a programmable logic device (PLD) in addition to or instead of the constituents. Examples of the PLD include a programmable array logic (PAL), a generic array logic (GAL), a complex programmable logic device (CPLD), and a field programmable gate array (FPGA). In this case, some or all of the functions realized by the processor may be realized by the integrated circuit.

By executing the program, the processor 151 functions as a bucket selection unit 1511, a connection determination unit 1512, an invert connection dimension calculation unit 1513, an operation amount acquisition unit 1514, a detection information acquisition unit 1515, a bucket position specifying unit 1516, a control line determination unit 1517, a display control unit 1518, and an intervention control unit 1519.

The storage 155 is allocated with storage regions such as a work machine information storage unit 1551, a bucket information storage unit 1552, and a target construction data storage unit 1553.

The work machine information storage unit 1551 stores the boom length L1, the arm length L2, and a positional relationship between a position of the representative point O of the swing body 120 and the boom pin P1.

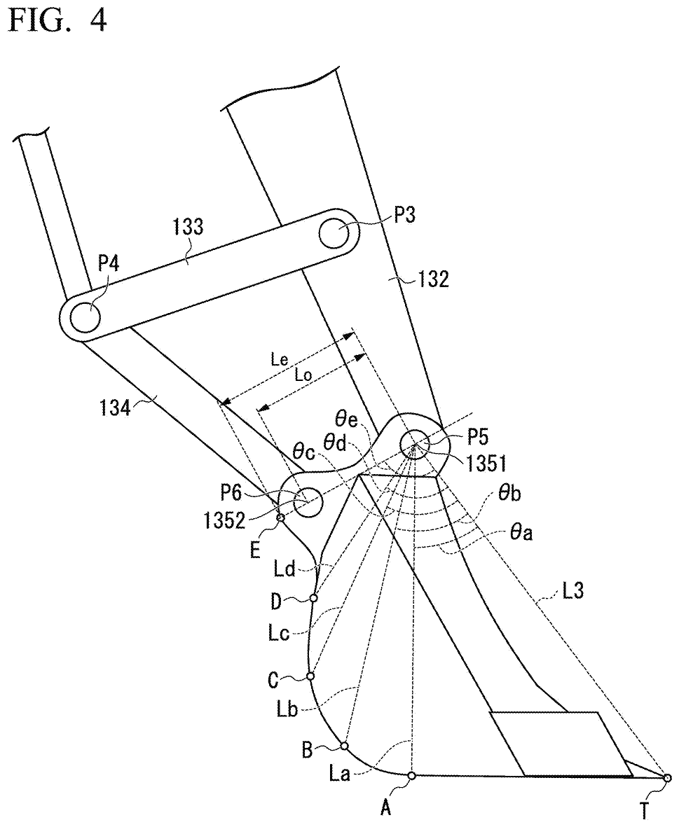

FIG. 4 is a diagram showing dimensions of the bucket in the normal connection state.

The bucket information storage unit 1552 stores a base-end portion length Lo that is a length between the front connection portion 1351 and the rear connection portion 1352 of the bucket 135, the bucket length L3 in the normal connection state, and relative positions of a plurality of contour points in the normal connection state in association with type information of the bucket 135. Specifically, the bucket information storage unit 1552 stores relative positions of a contour point A that is an intersection between a bottom straight line portion and a corner portion (heel portion) of the bucket 135, a contour point E that is an intersection between the contour of the bucket 135 and a straight line passing through the front connection portion 1351 and the rear connection portion 1352, and contour points B, C, and D that equally divide a portion between the contour point A and the contour point E. Examples of the type information of the bucket 135 include a model number, the name, and an ID of the bucket 135.

The relative positions of the plurality of contour points with the bucket pin P5 as a reference are represented by, for example, lengths La, Lb, Lc, Ld, and Le from the bucket pin P5 to the respective contour points, and angles θa, θb, θc, θd, and θe formed between a straight line passing through the bucket pin P5 and the contour point and a straight line passing through the bucket pin P5 and the teeth T. The bucket information storage unit 1552 is an example of a dimension storage unit.

Hereinafter, the bucket length L3 in the normal connection state will also be referred to as a bucket length L3n. The lengths La, Lb, Lc, Ld, and Le to the respective contour points in the normal connection state will also be respectively referred to as lengths Lan, Lbn, Lcn, Ldn, and Len. The angles θa, θb, θc, θd, and θe of the respective contour points in the normal connection state will also be respectively referred to as θan, θbn, θcn, θdn, and θen. The bucket length L3n, the lengths Lan, Lbn, Lcn, Ldn, Len, and the angles θan, θbn, θcn, θdn, and θen are examples of first dimensions or second dimensions of another embodiment which will be described later. The lengths Lan, Lbn, Lcn, Ldn, and Len, and the angles θan, θbn, θcn, θdn, and θen are examples of first contour positions or second contour positions of another embodiment which will be described later.

The target construction data storage unit 1553 stores target construction data representing the design surface at the construction site. The target construction data is three-dimensional data represented by the site coordinate system, and is stereoscopic topographic data formed of a plurality of triangular polygons representing the design surface. The triangular polygons forming the target construction data have common sides with other adjacent triangular polygons. That is, the target construction data represents a continuous plane formed of a plurality of planes. The target construction data is read from an external storage medium or is received from an external server via a network to be stored in the target construction data storage unit 1553.

The bucket selection unit 1511 displays a selection screen for the bucket 135 stored in the bucket information storage unit 1552 on the input/output device 160. The bucket selection unit 1511 also receives selection of the bucket 135 from an operator via the input/output device 160.

The connection determination unit 1512 receives input of connection information indicating whether the bucket 135 is in the normal connection state or the invert connection state, via the input/output device 160.

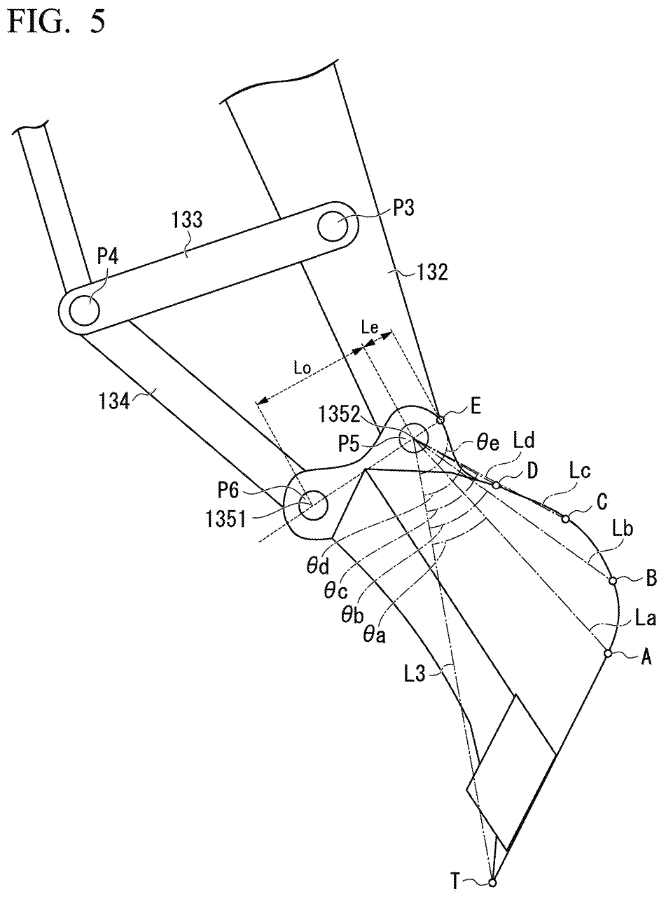

FIG. 5 is a diagram showing dimensions of the bucket in the invert connection state.

The invert connection dimension calculation unit 1513 calculates dimension information of the bucket 135 in the invert connection state on the basis of the dimension information of the bucket 135 in the normal connection state stored in the bucket information storage unit 1552. That is, the invert connection dimension calculation unit 1513 calculates the bucket length L3 in the invert connection state, the lengths La, Lb, Lc, Ld, and Le from the bucket pin P5 to the plurality of contour points, and the angles θa, θb, θc, θd, and θe of the plurality of contour points in the invert connection state. The invert connection dimension calculation unit 1513 is an example of a dimension calculation unit.

Hereinafter, the bucket length L3 in the invert connection state will also be referred to as a bucket length L3i. The lengths La, Lb, Lc, Ld, and Le to the respective contour points in the invert connection state will also be respectively referred to as lengths Lai, Lbi, Lci, Ldi, and Lei. The angles of the contour points in the invert connection state will also be respectively indicated by θai, θbi, θci, θdi, and θei. The bucket length L3i, the lengths Lai, Lbi, Lci, Ldi, and Lei and the angles θai, θbi, θci, θdi, and θei are examples of second dimensions or first dimensions of another embodiment which will be described later. The lengths Lai, Lbi, Lci, Ldi, and Lei and the angles θai, θbi, θci, θdi, and θei are examples of second contour positions or first contour positions of another embodiment which will be described later.

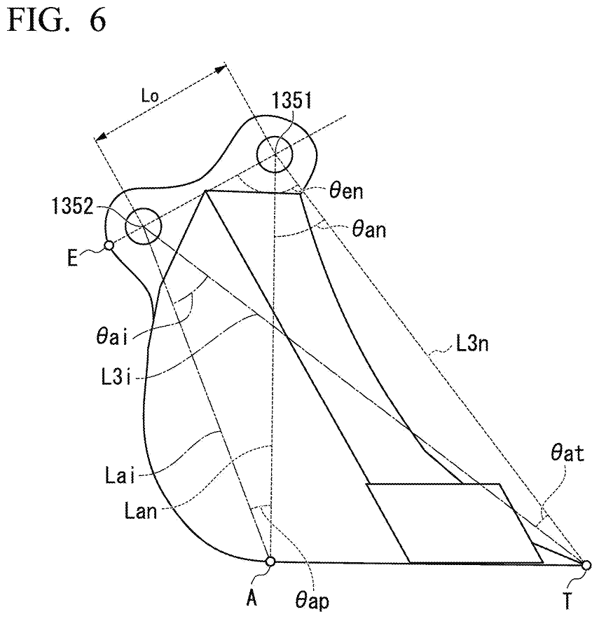

FIG. 6 is a diagram showing a method of calculating dimensions of the bucket in the invert connection state.

The invert connection dimension calculation unit 1513 calculates the bucket length L3i in the invert connection state according to the following equation (1).

L3i²=L3n²+Lo²−2*L3n*Lo*cos θen (1)

That is, the invert connection dimension calculation unit 1513 may calculate the bucket length L3i in the invert connection state according to the cosine theorem by using the bucket length L3n, the base-end portion length Lo, and the angle θen in the normal connection state. Since the contour point E is an intersection between the straight line passing through the front connection portion 1351 and the rear connection portion 1352 and the contour of the bucket 135, the angle θen is equivalent to a normal connection teeth angle that is an angle formed between the straight line passing through the front connection portion 1351 and the rear connection portion 1352 and the straight line passing through the front connection portion 1351 and the teeth T in the normal connection state. The normal connection teeth angle, that is, the angle θen is an example of a first teeth angle or a second teeth angle of another embodiment which will be described later.

The invert connection dimension calculation unit 1513 calculates the length Lai of the contour point A from the bucket pin P5 in the invert connection state according to the following equation (2).

Lai²=Lan²+Lo²−2*Lan*Lo*cos(θen−θan) (2)

That is, the invert connection dimension calculation unit 1513 may calculate the length Lai of the contour point A from the bucket pin P5 in the invert connection state according to the cosine theorem by using the length Lan of the contour point A from the bucket pin P5, the base-end portion length Lo, the angle θen, and the angle θan in the normal connection state. Similarly, the invert connection dimension calculation unit 1513 calculates the lengths Lbi, Lci, Ldi, and Lei in the same manner as for the other contour points B, C, D, and E.

The invert connection dimension calculation unit 1513 calculates the angle θai of the contour point A in the invert connection state according to the following equation (3).

θai=arccos((L3i²+Lai²−AT²)/(2*L3i*Lai)) (3)

That is, the invert connection dimension calculation unit 1513 may calculate the angle θai of the contour point A in the invert connection state according to the cosine theorem by using the bucket length L3i in the invert connection state, the length Lai of the contour point A from the bucket pin P5 in the invert connection state, and a distance AT between the contour point A and the teeth T. Similarly, the invert connection dimension calculation unit 1513 calculates the angles θbi, θci, θdi, and θei in the same manner as for the other contour points B, C, D, and E. The angle θei is equivalent to an invert contact teeth angle that is an angle formed between the straight line passing through the front connection portion 1351 and the rear connection portion 1352 and the straight line passing through the rear connection portion 1352 and the teeth T in the invert connection state. The invert connection teeth angle, that is, the angle θei is an example of a second teeth angle or a first teeth angle of another embodiment which will be described later.

The operation amount acquisition unit 1514 acquires an operation signal indicating an operation amount from the operation device 121. The operation amount acquisition unit 1514 acquires at least an operation amount related to the boom 131, an operation amount related to the arm 132, and an operation amount related to the bucket 135.

The detection information acquisition unit 1515 acquires information detected by each of the boom stroke sensor 141, the arm stroke sensor 142, the bucket stroke sensor 143, the position and azimuth direction calculator 144, and the tilt detector 145. That is, the detection information acquisition unit 1515 acquires position information of the swing body 120 in the site coordinate system, an azimuth direction in which the swing body 120 is directed, a posture of the swing body 120, a stroke length of the boom cylinder 136, a stroke length of the arm cylinder 137, and a stroke length of the bucket cylinder 138.

The bucket position specifying unit 1516 specifies a position and a posture of the bucket 135 on the basis of the information acquired by the detection information acquisition unit 1515. In this case, the bucket position specifying unit 1516 specifies the bucket absolute angle η. The bucket position specifying unit 1516 specifies the bucket absolute angle η according to the following procedure. The bucket position specifying unit 1516 calculates the boom relative angle α by using the stroke length of the boom cylinder 136. The bucket position specifying unit 1516 calculates the arm relative angle β by using the stroke length of the arm cylinder 137. The bucket position specifying unit 1516 calculates the bucket relative angle γ by using the stroke length of the bucket cylinder 138. The bucket position specifying unit 1516 calculates the bucket absolute angle η by adding the boom relative angle α, the arm relative angle β, and the bucket relative angle γ together.

The bucket position specifying unit 1516 specifies a position of the teeth T of the bucket 135 in the site coordinate system on the basis of the information acquired by the detection information acquisition unit 1515 and the information stored in the work machine information storage unit 1551. The bucket position specifying unit 1516 specifies the position of the teeth T of the work equipment 130 in the site coordinate system according to the following procedure. The bucket position specifying unit 1516 specifies a position of the arm pin P2 in the vehicle body coordinate system on the basis of the boom relative angle α acquired by the detection information acquisition unit 1515 and the boom length L1 stored in the work machine information storage unit 1551. The bucket position specifying unit 1516 specifies a position of the bucket pin P5 in the vehicle body coordinate system on the basis of the position of the arm pin P2, the arm relative angle β acquired by the detection information acquisition unit 1515, and the arm length L2 stored in the work machine information storage unit 1551. The bucket position specifying unit 1516 specifies a position and a posture of the teeth T of the bucket 135 on the basis of the position of the bucket pin P5, the bucket relative angle γ acquired by the detection information acquisition unit 1515, and the bucket length L3. In this case, when the bucket 135 is in the normal connection state, the bucket position specifying unit 1516 specifies the position and the posture of the teeth T of the bucket 135 on the basis of the bucket length L3 stored in the bucket information storage unit 1552. On the other hand, when the bucket 135 is in the invert connection state, the bucket position specifying unit 1516 specifies the position and the posture of the teeth T of the bucket 135 on the basis of the bucket length L3 calculated by the invert connection dimension calculation unit 1513. The bucket position specifying unit 1516 converts the position of the teeth T of the bucket 135 in the vehicle body coordinate system into a position in the site coordinate system on the basis of the position information of the swing body 120 in the site coordinate system acquired by the detection information acquisition unit 1515, the azimuth direction in which the swing body 120 is directed, and the posture of the swing body 120. The bucket position specifying unit 1516 is an example of an attachment position specifying unit.

The control line determination unit 1517 determines a control line used for intervention control on the bucket 135. The control line determination unit 1517 determines, for example, an intersection line between a vertical section of the bucket 135 and the design surface as the control line.

The display control unit 1518 generates a diagram indicating a positional relationship between the position of the bucket 135 in the site coordinate system specified by the bucket position specifying unit 1516 and the control line determined by the control line determination unit 1517, and displays the diagram on the input/output device 160. In this case, the display control unit 1518 generates a graphic representing a shape of the bucket 135 on the basis of the relative positions of the contour points of the bucket 135, and draws the graphic on the input/output device 160. In a case where the bucket 135 is in the normal connection state, the display control unit 1518 generates the graphic of the bucket 135 on the basis of the relative positions of the contour points stored in the bucket information storage unit 1552. On the other hand, in a case where the bucket 135 is in the invert connection state, the display control unit 1518 generates a graphic of the bucket 135 on the basis of relative positions of the contour points calculated by the invert connection dimension calculation unit 1513. The display control unit 1518 is an example of a drawing information generation unit and an attachment drawing unit.

The intervention control unit 1519 performs intervention control on the work equipment 130 on the basis of the operation amount in the operation device 121 acquired by the operation amount acquisition unit 1514 and a distance between the control line determined by the control line determination unit 1517 and the bucket 135.

### <<Bucket Setting Method>>

Hereinafter, a method of controlling the work machine 100 according to the first embodiment will be described.

First, an operator of the work machine 100 sets information regarding the bucket 135 included in the work machine 100 by using the input/output device 160.

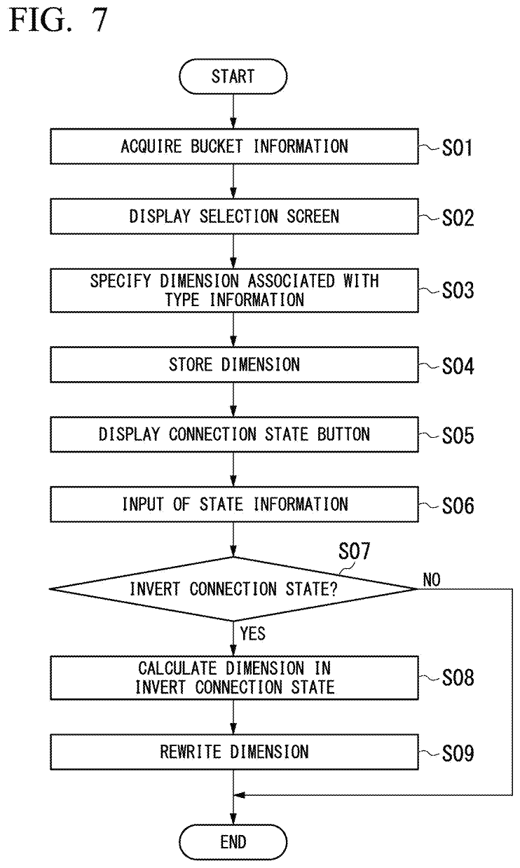

FIG. 7 is a flowchart showing a bucket setting method for the work machine according to the first embodiment.

The bucket selection unit 1511 of the work equipment control device 150 reads the information regarding the bucket 135 stored in the bucket information storage unit 1552 (step S01). The bucket selection unit 1511 outputs a display signal for displaying a selection screen for the bucket 135 to the input/output device 160 on the basis of the read information (step S02). Consequently, the selection screen for the bucket 135 is displayed on the input/output device 160. The operator selects the bucket 135 attached to the work machine 100 from the selection screen displayed on the input/output device 160. The bucket selection unit 1511 specifies dimensions of the bucket 135 in the normal connection state associated with the selected bucket 135 from the bucket information storage unit 1552 (step S03). The bucket selection unit 1511 stores the read dimensions of the bucket 135 into the main memory 153 (step S04).

Next, the connection determination unit 1512 outputs a display signal for connection state buttons for selecting whether a connection state of the bucket 135 is the normal connection state or the invert connection state, to the input/output device 160 (step 505). Examples of the connection state buttons include a check box indicating the invert connection state during an ON state and the normal connection state during an OFF state, and a combination of a button indicating the normal connection state and a button indicating the invert connection state, and a list box from which state information is selectable. The operator presses a button indicating the connection state of the work machine 100 from the connection state buttons displayed on the input/output device 160. The connection determination unit 1512 receives input of the state information by pressing the button (step S06).

The connection determination unit 1512 determines whether or not the state information indicates the invert connection state (step S07). In a case where the state information indicates the invert connection state (step S07: YES), the invert connection dimension calculation unit 1513 calculates dimensions of the bucket 135 in the invert connection state on the basis of the dimensions of the bucket 135 in the normal connection state stored in the main memory in step S04 (step S08). That is, the invert connection dimension calculation unit 1513 calculates the bucket length L3 in the invert connection state, the lengths La, Lb, Lc, Ld, and Le from the bucket pin P5 to the plurality of contour points in the invert connection state, and the angles θa, θb, θc, θd, and θe of a plurality of contour points in the invert connection state on the basis of the above Equations (1) to (3). In this case, the invert connection dimension calculation unit 1513 also calculates a relative position of the bucket link pin P6 in the invert connection state, that is, a relative position of the front connection portion 1351. The invert connection dimension calculation unit 1513 rewrites the dimensions of the bucket 135 stored in the main memory 153 into the calculated dimensions of the bucket 135 in the invert connection state (step S09).

In a case where the state information indicates the normal connection state (step S07: NO), the invert connection dimension calculation unit 1513 does not rewrite the dimensions of the bucket 135 stored in the main memory 153.

### <<Control Method During Operation>>

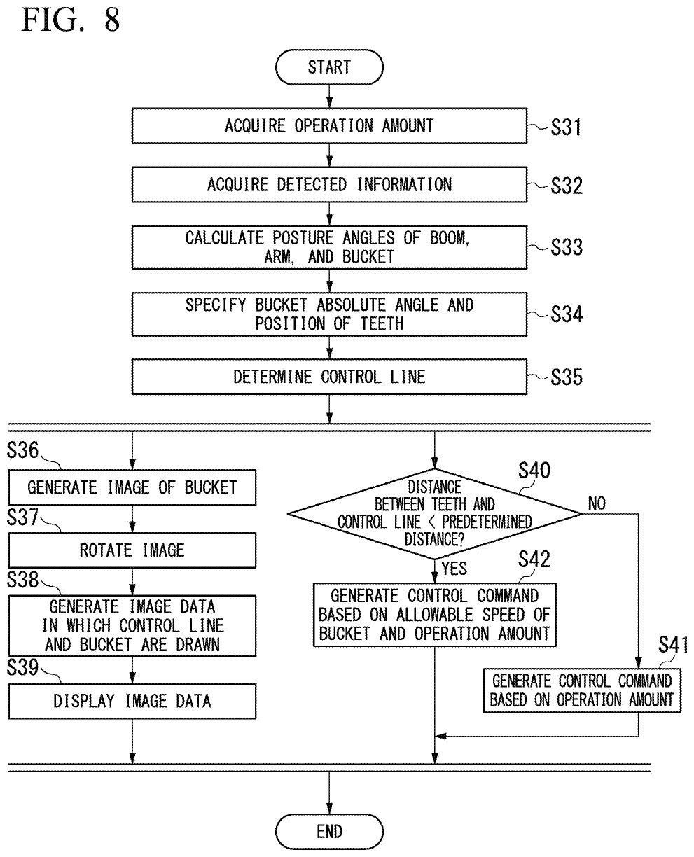

FIG. 8 is a flowchart showing a bucket image display process and an intervention control process using the dimensions set in the above control method. When the operator of the work machine 100 starts to operate the work machine 100, the work equipment control device 150 executes the following control in each predetermined control cycle.

The operation amount acquisition unit 1514 acquires an operation amount related to the boom 131, an operation amount related to the arm 132, an operation amount related to the bucket 135, and an operation amount related to swing, from the operation device 121 (step S31). The detection information acquisition unit 1515 acquires information detected by each of the position and azimuth direction calculator 144, the tilt detector 145, the boom cylinder 136, the arm cylinder 137, and the bucket cylinder 138 (step S32).

The bucket position specifying unit 1516 calculates the boom relative angle α, the arm relative angle β, and the bucket relative angle γ by using the stroke length of each hydraulic cylinder (step S33). The bucket position specifying unit 1516 calculates the bucket absolute angle η and a position of the teeth T of the bucket 135 in the site coordinate system on the basis of the calculated relative angles α, β, and γ, the boom length L1 and the arm length L2 stored in the work machine information storage unit 1551, the bucket length L3 stored in the main memory 153, and the position, the azimuth direction, and the posture of the swing body 120 acquired by the detection information acquisition unit 1515 (step S34).

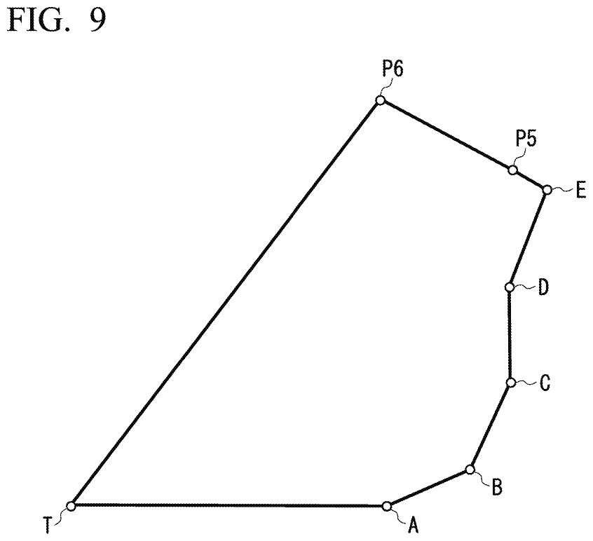

The control line determination unit 1517 determines a control line on the basis of the teeth T of the bucket 135 and the target construction data stored in the target construction data storage unit 1553 (step S35). The display control unit 1518 generates an image of the bucket 135 on the basis of the dimensions of the bucket 135 stored in the main memory 153 (step S36). FIG. 9 is a diagram showing an example of a bucket image. The image of the bucket 135 may be drawn, for example, by a convex hull of a plurality of points representing the positions of the teeth T, the contour points A, B, C, D, E, the bucket pin P5, and the bucket link pin P6 of the bucket 135. An image drawn by a convex hull of a plurality of points is an example of drawing information. The display control unit 1518 rotates the generated image on the basis of the bucket absolute angle η (step S37). The display control unit 1518 converts the acquired position of the teeth T and the acquired control line into a position in an image coordinate system and generates screen data in which a line segment representing the control line and the image of the bucket 135 are drawn (step S38). The display control unit 1518 outputs the generated screen data to the input/output device 160 (step S39). Consequently, a screen representing a positional relationship between the bucket 135 and the design surface is displayed on the input/output device 160.

In parallel to the screen data display process in steps S36 to S39, the intervention control unit 1519 determines whether or not a distance between each of the teeth T and the contour points A, B, C, D, E and the control line is less than a predetermined distance (step S40). In a case where the distance between each of the teeth T and the contour points A, B, C, D, E and the control line is not less than the predetermined distance (step S40: NO), the intervention control unit 1519 does not perform the intervention control and generates a control command for the work equipment 130 based on the operation amount acquired by the operation amount acquisition unit 1514 (step S41). On the other hand, in a case where the distance between at least one of the teeth T and at least one of the contour points A, B, C, D, and E and the control line is less than the predetermined distance (step S40: YES), the intervention control unit 1519 generates a control command for the work equipment 130 on the basis of an allowable speed of the bucket 135 specified by using the distance between the teeth T and the control line, and the operation amount acquired by the operation amount acquisition unit 1514 (step S42).

### <<Operation and Effect>>

As described above, according to the first embodiment, the work equipment control device 150 calculates the bucket length L3i in the invert connection state on the basis of the bucket length L3n in the normal connection state. Consequently, the work equipment control device 150 can specify dimensions of the bucket 135 in the invert connection state. In other embodiments, the work equipment control device 150 may calculate the bucket length L3n in the normal connection state on the basis of the bucket length L3i in the invert connection state. In this case, the work equipment control device 150 can specify dimensions of the bucket 135 in the normal connection state when dimensions of the bucket 135 in the invert connection state are known. In this case, the bucket length L3i is an example of a first dimension, and the bucket length L3n is an example of a second dimension.

According to the first embodiment, the work equipment control device 150 calculates the bucket length L3i in the invert connection state on the basis of the bucket length L3n, the base-end portion length Lo, and the angle θen in the normal connection state. Consequently, the work equipment control device 150 can calculate the bucket length L3i in the invert connection state on the basis of the cosine theorem.

According to the first embodiment, the work equipment control device 150 receives input of the connection information, and specifies a position of the bucket 135 in the site coordinate system on the basis of the bucket length L3n in the normal connection state in a case where the connection state is the normal connection state and displays a position of the bucket 135 in the site coordinate system on the basis of the bucket length L3i in the invert connection state in a case where the connection state is the invert connection state. Consequently, the work equipment control device 150 can accurately display a position of the bucket 135 and accurately perform intervention control regardless of a connection state of the bucket 135.

According to the first embodiment, the work equipment control device 150 calculates relative positions of the contour points A, B, C, D, and E in the invert connection state with respect to the plurality of contour points A, B, C, D, and E of the bucket 135 and draws a shape of the bucket on the basis of the calculated relative positions. Consequently, the work equipment control device 150 can accurately display a shape of the bucket 135 regardless of a connection state of the bucket 135.

According to the first embodiment, the work equipment control device 150 receives input of type information of the bucket 135, and calculates the bucket length L3i in the invert connection state with respect to the bucket 135 related to the input type information. Consequently, even in a case where the bucket 135 is replaced, a dimension of the bucket 135 in the invert connection state can be appropriately specified.

Although one embodiment has been described above in detail with reference to the drawings, a specific configuration is not limited to the above configuration, and various design changes and the like may occur.

The work equipment control device 150 according to the above-described embodiment performs display of a position of the teeth T in steps S36 to S39 and intervention control in steps S40 to S42 on the basis of the calculated bucket length L3, but is not limited thereto. For example, the work equipment control device 150 according to other embodiments may perform one of the display of a position of the teeth T and the intervention control, or other processes based on the bucket length L3.

The work equipment control device 150 according to the above-described embodiment draws a graphic of the bucket 135 on the basis of positions of the teeth T, the contour points A, B, C, D, and E, the bucket pin P5, and the bucket link pin P6 of the bucket 135, but is not limited thereto. For example, the work equipment control device 150 according to other embodiments may draw the graphic of the bucket 135 in the invert connection state by inverting an image of the bucket 135 in the normal connection state stored in advance.

The work equipment control device 150 according to the above-described embodiment calculates the bucket length L3i in the invert connection state on the basis of the cosine theorem, but is not limited thereto. For example, the work equipment control device 150 according to other embodiments may calculate the bucket length L3i in the invert connection state on the basis of the sine or tangent theorem. In other words, for any triangle including a line segment that connects the tip-end portion of the arm 132 to the teeth T in the invert connection state, when a parameter that satisfies the triangle determination condition is known, the work equipment control device 150 can calculate the bucket length L3i in the invert connection state.

Thee work equipment control device 150 according to other embodiments may calculate the bucket length L3i in the invert connection state by using the base-end portion length Lo instead of using the bucket length L3n in the normal connection state. For example, the invert connection dimension calculation unit 1513 calculates the length Lai on the basis of the above Equation (2).

Next, the invert connection dimension calculation unit 1513 obtains an angle θap formed between a straight line passing through the front connection portion 1351 and the contour point A and a straight line passing through the rear connection portion 1352 and the contour point A on the basis of the following Equation (4). The invert connection dimension calculation unit 1513 obtains an angle θat formed between a straight line passing through the contour point A and the teeth T and a straight line passing through the front connection portion 1351 and the contour point A on the basis of the following Equation (5).

θap=arccos((Lan²+Lai²−Lo²)/(2*Lan*Lai)) (4)

θat=arccos((Lan²+AT²−L3n²)/(2*Lan*AT)) (5)

The invert connection dimension calculation unit 1513 calculates the bucket length L3i in the invert connection state on the basis of the following Equation (6).

L3i²=AE²+AT²−2*AE*AT*cos(θap+θat) (6)

In other embodiments, in a case where a distance between the rear connection portion 1352 and the contour point E is sufficiently short, the length Len may be used as the base-end portion length instead of the length Lo. That is, the base-end portion length is not necessarily required to match a distance between the front connection portion 1351 and the rear connection portion 1352.

The work equipment control device 150 according to the above-described embodiment converts a position of the bucket 135 from the vehicle body coordinate system to the site coordinate system in order to display image data in which the control line and the bucket 135 are drawn, but is not limited thereto. For example, in other embodiments, the work equipment control device 150 may convert a position of a design surface indicated by target construction data from the site coordinate system to the vehicle body coordinate system. In other embodiments, the work equipment control device 150 may convert positions of the control line and the bucket 135 into positions in another coordinate system.

The work equipment control device 150 according to the above-described embodiment determines a connection state on the basis of pressing of the connection state button, but is not limited thereto. For example, the work equipment control device 150 according to other embodiments may determine a connection state by using cylinder pressure applied to the arm 132 or the boom 131 or image analysis using a stereo camera or the like, or other methods regardless of whether or not the connection state button is pressed.

The work equipment control device 150 according to the above-described embodiment calculates a dimension of the bucket 135 in the invert connection state by using a dimension of the bucket 135 in the normal connection state, but is not limited thereto. In other embodiments, the work equipment control device 150 may calculate a dimension of the bucket 135 in the normal connection state by using a dimension of the bucket 135 in the invert connection state as described below. In this case, the work equipment control device 150 includes a normal connection dimension calculation unit instead of the invert connection dimension calculation unit 1513, and the bucket information storage unit 1552 stores dimension information of the bucket 135 in the invert connection state. The normal connection dimension calculation unit is an example of a dimension calculation unit.

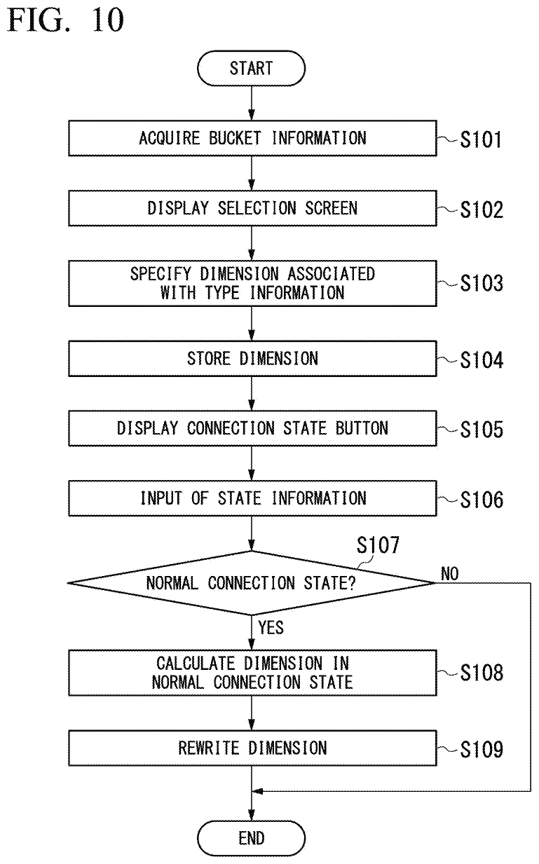

FIG. 10 is a flowchart showing a bucket setting method for a work machine according to another embodiment.

The bucket selection unit 1511 of the work equipment control device 150 reads the information regarding the bucket 135 stored in the bucket information storage unit 1552 (step S101). The bucket selection unit 1511 outputs a display signal for displaying a selection screen for the bucket 135 to the input/output device 160 on the basis of the read information (step S102). Consequently, the selection screen for the bucket 135 is displayed on the input/output device 160. The operator selects the bucket 135 attached to the work machine 100 from the selection screen displayed on the input/output device 160. The bucket selection unit 1511 specifies dimensions of the bucket 135 in the invert connection state associated with the selected bucket 135 from the bucket information storage unit 1552 (step S103). The bucket selection unit 1511 stores the read dimensions of the bucket 135 into the main memory 153 (step S104).

Next, the connection determination unit 1512 outputs a display signal for connection state buttons for selecting whether a connection state of the bucket 135 is the normal connection state or the invert connection state, to the input/output device 160 (step S105). The operator presses a button indicating the connection state of the work machine 100 from the connection state buttons displayed on the input/output device 160. The connection determination unit 1512 receives input of the state information by pressing the button (step S106).

The connection determination unit 1512 determines whether or not the state information indicates the normal connection state (step S107). In a case where the state information indicates the normal connection state (step S107: YES), the normal connection dimension calculation unit calculates dimensions of the bucket 135 in the normal connection state on the basis of the dimensions of the bucket 135 in the invert connection state stored in the main memory in step S104 (step S108). The normal connection dimension calculation unit rewrites the dimensions of the bucket 135 stored in the main memory 153 into the calculated dimensions of the bucket 135 in the normal connection state (step S109).

On the other hand, in a case where the state information indicates the invert connection state (step S107: NO), the normal connection dimension calculation unit does not rewrite the dimensions of the bucket 135 stored in the main memory 153.

Accordingly, the work equipment control device 150 can calculate a dimension of the bucket 135 in the normal connection state by using a dimension of the bucket 135 in the invert connection state.

According to the present invention, the dimension-specifying device can specify a dimension of a bucket regardless of a bucket attachment method.

1. A dimension-specifying device specifying dimensions of an attachment of work equipment including an arm and the attachment and in which a first connection portion or a second connection portion provided at the attachment is connected to the arm, the dimension-specifying device comprising:
a dimension storage unit storing first dimensions of the attachment when the first connection portion is connected to the arm; and
a dimension calculation unit calculating second dimensions of the attachment when the second connection portion is connected to the arm based on the first dimensions.

2. The dimension-specifying device according to claim 1, wherein
the attachment is a bucket having teeth, and
either the first dimensions or the second dimensions or both the first and second dimensions include a bucket length indicating a length from the arm to the teeth.

3. The dimension-specifying device according to claim 2, wherein
the dimension storage unit stores
a base-end portion length between the first connection portion and the second connection portion, and
a first teeth angle formed between
a straight line passing through the first connection portion and the second connection portion and
a straight line passing through the first connection portion and the teeth, and
the dimension calculation unit calculates the second dimensions based on the first dimensions, the base-end portion length, and the first teeth angle.

4. The dimension-specifying device according to claim 1, further comprising:
a connection determination unit determining whether the arm is connected to the first connection portion or the second connection portion,
the dimension calculation unit calculating the second dimensions based on the first dimensions in a case in which it is determined that the arm is connected to the second connection portion.

5. The dimension-specifying device according to claim 1, wherein
the dimension storage unit stores, as the first dimensions, first contour positions of a plurality of contour points of the attachment with the arm as a reference when the first connection portion is connected to the arm, and
the dimension calculation unit calculates, as the second dimensions, second contour positions of the plurality of contour points with the arm as a reference when the second connection portion is connected to the arm based on the first contour position.

6. The dimension-specifying device according to claim 1, further comprising:
a drawing information generation unit generating drawing information to draw a shape of the attachment based on the second dimensions; and
an attachment drawing unit outputting an image indicating the shape of the attachment based on the drawing information.

7. The dimension-specifying device according to claim 1, further comprising:
a type input unit receiving input of type information indicating a type of the attachment,
the dimension storage unit storing, for each type information of the attachment, the first dimensions of the attachment related to the type, and
the dimension calculation unit calculating the second dimensions based on the basis of the first dimensions related to the type indicated by the input type information.

8. A dimension-specifying method of specifying dimensions of an attachment of work equipment including an arm and the attachment and in which a first connection portion or a second connection portion provided at the attachment is connected to the arm, the dimension-specifying method comprising:
acquiring first dimensions of the attachment when the first connection portion is connected to the arm; and
calculating second dimensions of the attachment when the second connection portion is connected to the arm based on the first dimensions.
